(19) United States
(12) Patent Application Publication
(10) Pub. No.: US 2016/0084486 A1
(43) Pub. Date: Mar. 24, 2016

(54) LIGHTING DEVICE CONTROLLABLE BY HOVER OPERATION

(71) Applicant: YICHENG PRECISION INC., Tainan City (TW)

(72) Inventors: Han-Chang CHEN, Taipei City (TW); Yen-Hung TU, Taipei City (TW); Jen-Chieh CHANG, Taipei City (TW); Chung-Lin CHIA, Taipei City (TW); Chih-Wen WU, Taipei City (TW)

(21) Appl. No.: 14/732,703

(22) Filed: Jun. 6, 2015

(30) Foreign Application Priority Data
Sep. 23, 2014 (TW) 103132737

(51) Int. Cl. F21V 23/04; F21V 8/00; H05B 33/08; F21V 29/70

(52) U.S. Cl. CPC F21V 23/0485; F21V 29/70; G02B 6/0073; G02B 6/0083; H05B 33/0896; H05B 33/0854; H05B 33/0872; F21Y 2101/02

(57) ABSTRACT

A lighting device controllable by hover operation, including: a shell body; a light source unit; at least one conductive sensor; and a circuit board, which includes a capacitive touch detection circuit, a light source driver circuit, and a control unit; wherein, when a finger or a palm of an operator approaches at least one active region of the shell body during a control operation, each of the at least one active region being opposing one of the at least one conductive sensor, the capacitive touch detection circuit will detect a capacitance change signal via the at least one conductive sensor and generate an operation signal accordingly, and the control unit will control the light source driver circuit in response to the operation signal to determine a light emitting status of the light source unit.

### BACKGROUND OF THE INVENTION

1. Field of the Invention

The present invention relates to a lighting device, especially to a lighting device controllable by hover operation.

2. Description of the Related Art

Please refer to FIG. 1a and FIG. 1b, which illustrate two lighting devices of prior art. As illustrated in FIG. 1a and FIG. 1b, both of the two lighting devices have a base 10, a supporting rod 20, an illumination part 30, and a switch 11. In FIG. 1a, the switch 11 is installed on a surface of the base 10; and in FIG. 1b, the switch 11 is installed on a surface of the illumination part 30.

The switch 11 is generally implemented by a mechanical switch or a touch switch. However, when the switch 11 is implemented by a mechanical switch, it is easy to get damaged by pressing operations, and dust and water can get in the switch 11 easily to shorten its operation life time.

When the switch 11 is implemented by a touch switch, a user has to actually touch the switch 11 to control the lighting device, but there are some situations (e.g., the hands of the user are wet or covered with dirt) not suitable for a user to do the touch operation (the touch operation under these circumstances may cause an electric shock to the user or soil the lighting device).

To solve the foregoing problems, a novel lighting device is needed.

### SUMMARY OF THE INVENTION

One objective of the present invention is to disclose a lighting device controllable by hover operation, which makes use of at least one existing metal part of a general lighting device as at least one sensor electrode to provide a hover function and/or a gesture function.

Another objective of the present invention is to disclose a lighting device controllable by hover operation, which is capable of providing a slim outline.

Another objective of the present invention is to disclose a lighting device controllable by hover operation, which is capable of providing a curved surface for both outputting light and sensing a hover operation.

Another objective of the present invention is to disclose a lighting device controllable by hover operation, which allows a user to adjust the intensity and color of the output light by a hover operation or a gesture operation.

Another objective of the present invention is to disclose a lighting device controllable by hover operation, which is capable of preventing dust and water from entering the device.

Still another objective of the present invention is to disclose a lighting device controllable by hover operation, which is capable of prolonging the operation life time of the device.

To attain the foregoing objectives, a lighting device controllable by hover operation is proposed, including:
a shell body;
a light source unit located inside the shell body;
at least one conductive sensor located inside the shell body;
a circuit board including a capacitive touch detection circuit, a light source driver circuit, and a control unit, the capacitive touch detection circuit being coupled electrically with the at least one conductive sensor, the light source driver circuit being coupled electrically with the light source unit, and the control unit being coupled electrically with both the capacitive touch detection circuit and the light source driver circuit;
wherein, when a finger or a palm of an operator approaches at least one active region of the shell body during a control operation, each of the at least one active region being opposing one of the at least one conductive sensor, the capacitive touch detection circuit will detect at least one capacitance change signal via the at least one conductive sensor and generate at least one operation signal accordingly, and the control unit will control the light source driver circuit in response to the at least one operation signal to determine a light emitting status of the light source unit.

In one embodiment, at least one of the at least one conductive sensor has a light reflective surface.

In one embodiment, at least one of the at least one conductive sensor is also used as a heat dissipating member.

In one embodiment, the light source unit includes at least one LED.

In one embodiment, the light source unit further includes a light guide plate, wherein the at least one LED is located on at least one edge of the light guide plate, and the light reflective surface of one of the at least one conductive sensor is adjacent to a top surface of the light guide plate.

In one embodiment, the light source unit further includes a light guide plate, wherein the at least one LED is located on at least one edge of the light guide plate, and the light reflective surface of one of the at least one conductive sensor is glued to a top surface of the light guide plate.

In one embodiment, the light source unit has a plurality of colors of light.

In one embodiment, the light source unit includes at least one OLED.

In one embodiment, when the finger or the palm performs a gesture near the shell body, the capacitive touch detection circuit will detect the at least one capacitance change signal via the at least one conductive sensor and generate the at least one operation signal accordingly, and the control unit will control the light source driver circuit in response to the at least one operation signal to determine a light intensity of the light source unit.

In one embodiment, the light source unit has a plurality of colors of light, and when the finger or the palm performs a gesture near the shell body, the capacitive touch detection circuit will detect the at least one capacitance change signal via the at least one conductive sensor and generate the at least one operation signal accordingly, and the control unit will control the light source driver circuit in response to the at least one operation signal to determine a light color of the light source unit.

In one embodiment, the lighting device controllable by hover operation further includes an extended conductive sensor located inside or outside the shell body and coupled electrically with the at least one conductive sensor via a wire.

In one embodiment, the control unit has a USB interface for transmitting data with an information processing device so that the lighting device of the present invention can also be controlled by an external device, or for providing a DC power.

To make it easier for our examiner to understand the objective of the invention, its structure, innovative features, and performance, we use preferred embodiments together with the accompanying drawings for the detailed description of the invention.

### BRIEF DESCRIPTION OF THE DRAWINGS

FIG. 1a and FIG. 1b illustrate two lighting devices of prior art.

FIG. 2 is an illustrative view of a lighting device controllable by hover operation according to an embodiment of the present invention.

FIG. 3 illustrates an embodiment of an illumination part of the lighting device of FIG. 2.

FIG. 4 illustrates a circuit block diagram of an embodiment of a circuit board of the illumination part shown in FIG. 3.

FIG. 5a illustrates an embodiment of the present invention providing direct back-lighting illumination.

FIG. 5b illustrates a cross sectional view of the structure of FIG. 5a.

FIG. 6a illustrates an embodiment of the present invention providing edge-lighting illumination.

FIG. 6b illustrates a cross sectional view of the structure of FIG. 6a.

FIG. 7 illustrates an embodiment of the lighting device of the present invention having at least one extended conductive sensor.

FIG. 8a illustrates an embodiment of the present invention providing conductive sensors in sensor zones A, B, C, and D.

FIG. 8b illustrates a scenario where a user adjusts the intensity or color of the output light of the light source element of the present invention by a touching operation.

FIG. 8c illustrates a scenario where a user adjusts the intensity or color of the output light of the light source element of the present invention by a hover gesture operation.

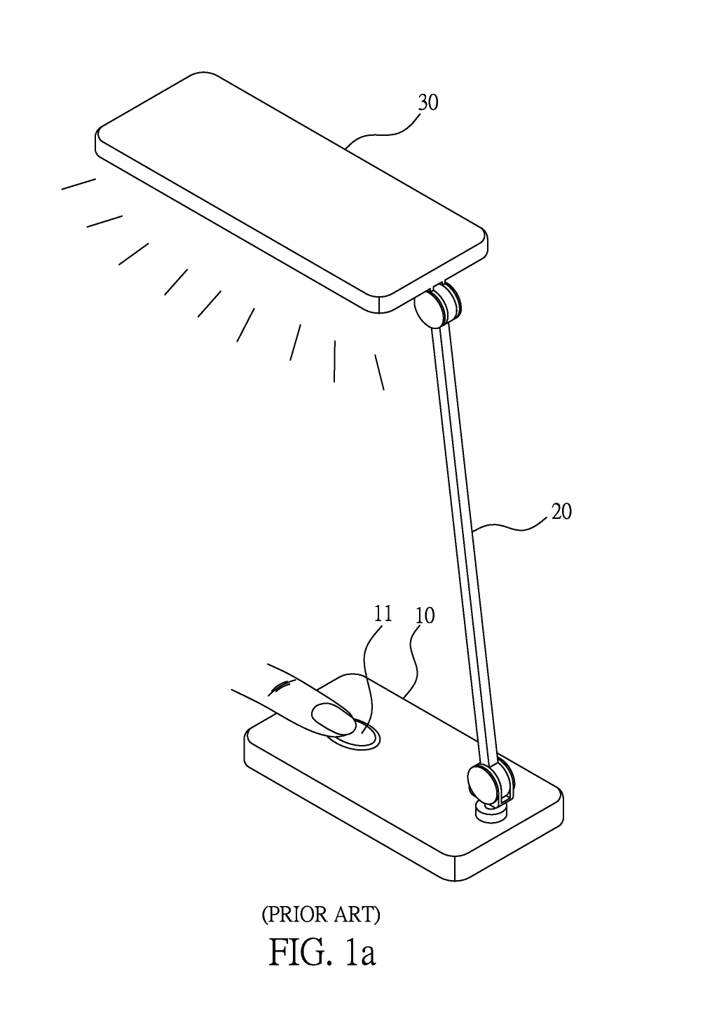

### DETAILED DESCRIPTION OF THE PREFERRED EMBODIMENTS

The present invention will be described in more detail hereinafter with reference to the accompanying drawings that show the preferred embodiments of the invention.

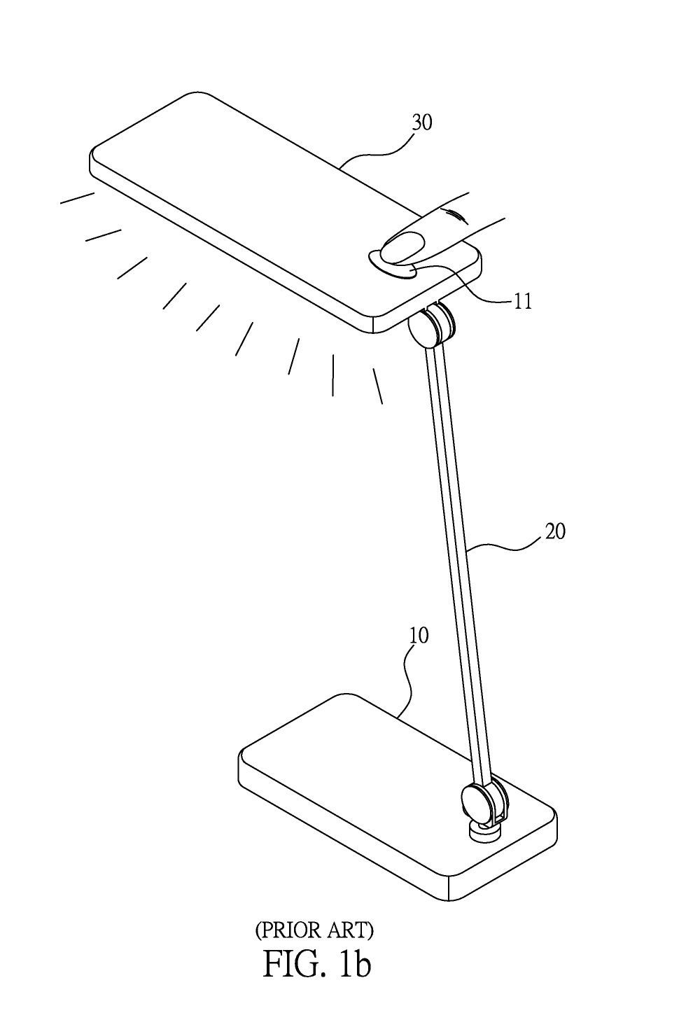

Please refer to FIG. 2, which shows an illustrative view of a lighting device controllable by hover operation according to an embodiment of the present invention. As illustrated in FIG. 2, the lighting device controllable by hover operation has a base 100, a supporting rod 110, and an illumination part 120. A user can float a finger or a palm above a top surface or below a bottom surface of the illumination part 120 to determine a light emitting status of the illumination part 120.

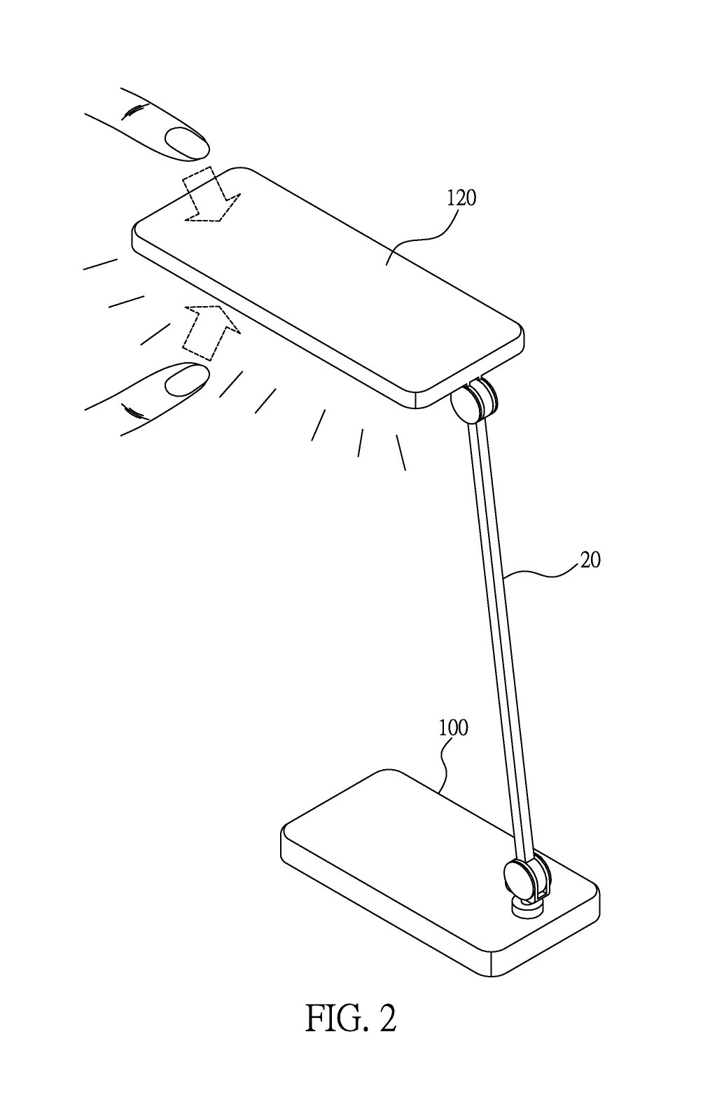

Please refer to FIG. 3, which illustrates an embodiment of the illumination part 120 of the lighting device of FIG. 2. As illustrated in FIG. 3, the illumination part 120 includes a shell body 121, a light source unit 122, at least one conductive sensor 123, and a circuit board 124.

The light source unit 122 is located inside the shell body 121 and can be implemented by one or more LEDs (light emitting diodes) or one or more OLEDs (organic light emitting diodes).

The at least one conductive sensor 123 is located inside the shell body 121 for serving as at least one sensing electrode, and at least one of the at least one conductive sensor 123 has a reflective surface 123a for reflecting light. Besides, at least one of the at least one conductive sensor 123 can also serve as a heat dissipating member.

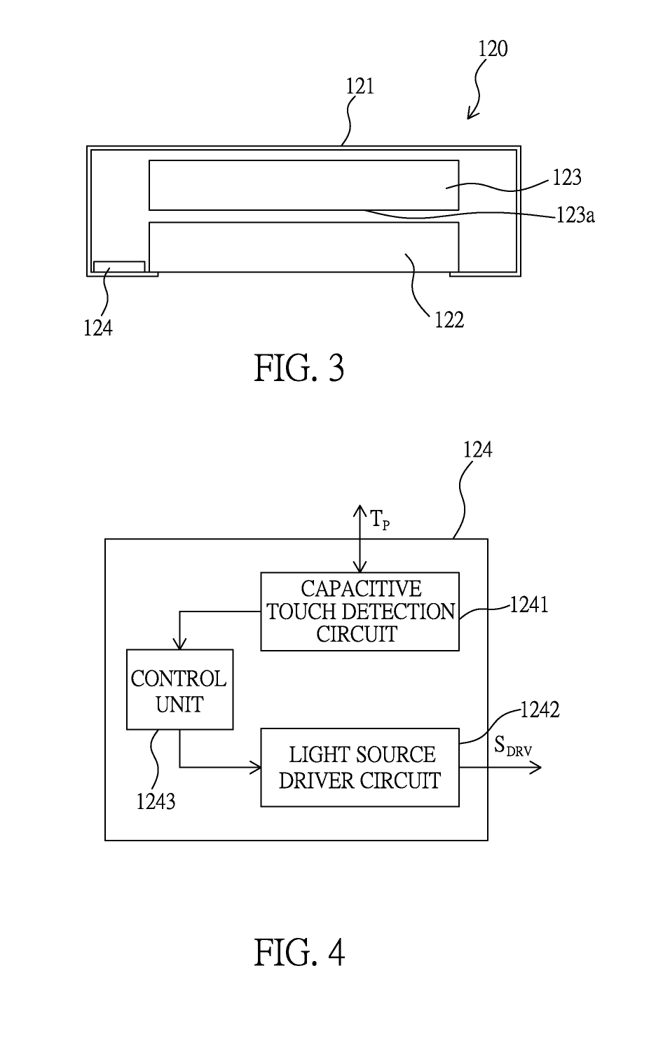

The circuit board 124 is located inside the shell body 121. Please refer to FIG. 4, which illustrates a circuit block diagram of an embodiment of the circuit board 124. As illustrated in FIG. 4, the circuit board 124 has a capacitive touch detection circuit 1241, a light source driver circuit 1242, and a control unit 1243, the capacitive touch detection circuit 1241 being coupled electrically with the at least one conductive sensor 123, the light source driver circuit 1242 being coupled electrically with the light source unit 122, and the control unit 1243 being coupled electrically with both the capacitive touch detection circuit 1241 and the light source driver circuit 1242.

When a finger or a palm of an operator floats on or touches at least one active region of the shell body 121 during a control operation, each of the at least one active region being opposing one of the at least one conductive sensor 123, the capacitive touch detection circuit 1241 will detect at least one capacitance change signal T_{P} via the at least one conductive sensor 123 and generate at least one operation signal accordingly, and the control unit 1243 will control the light source driver circuit 1242 in response to the at least one operation signal to determine a light emitting status of the light source unit 122.

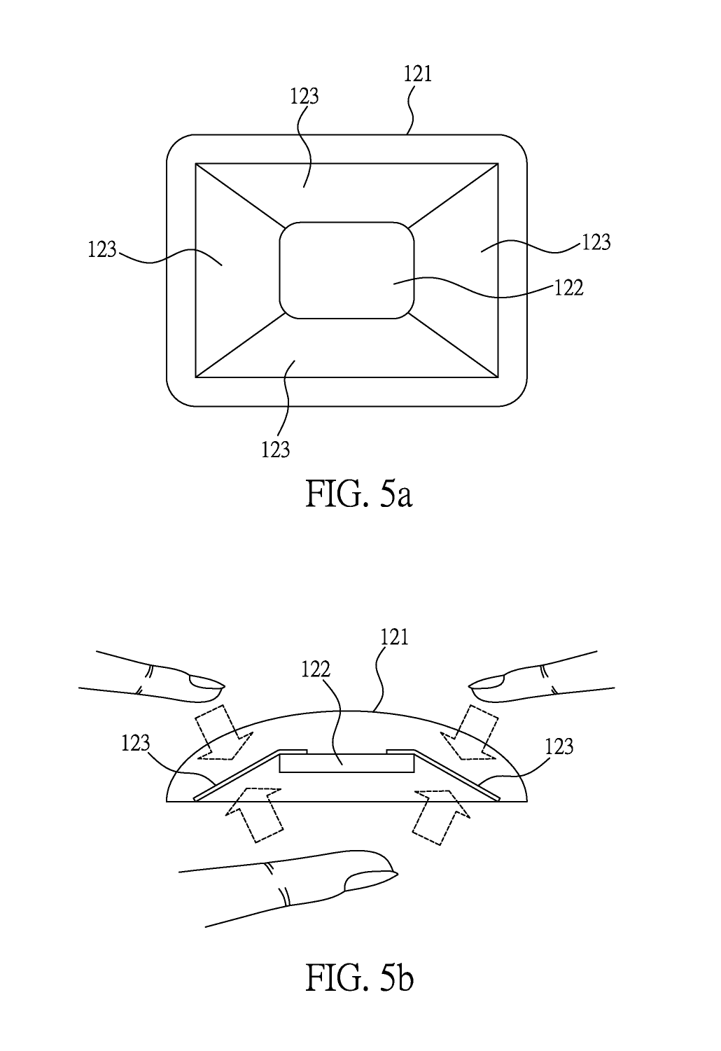

Please refer to FIG. 5a, which illustrates an embodiment of the present invention providing direct back-lighting illumination. As illustrated in FIG. 5a, there are one piece of the light source unit 122 implemented by at least one LED or OLED and four pieces of the conductive sensor 123 inside the shell body 121, wherein the at least one LED or OLED can have different light colors and the four pieces of the conductive sensor 123 also have a light reflecting function. Please refer to FIG. 5b, which illustrates a cross sectional view of the structure of FIG. 5a. As illustrated in FIG. 5b, a user can float a finger above or below the shell body 121 to determine a light emitting status of the light source unit 122.

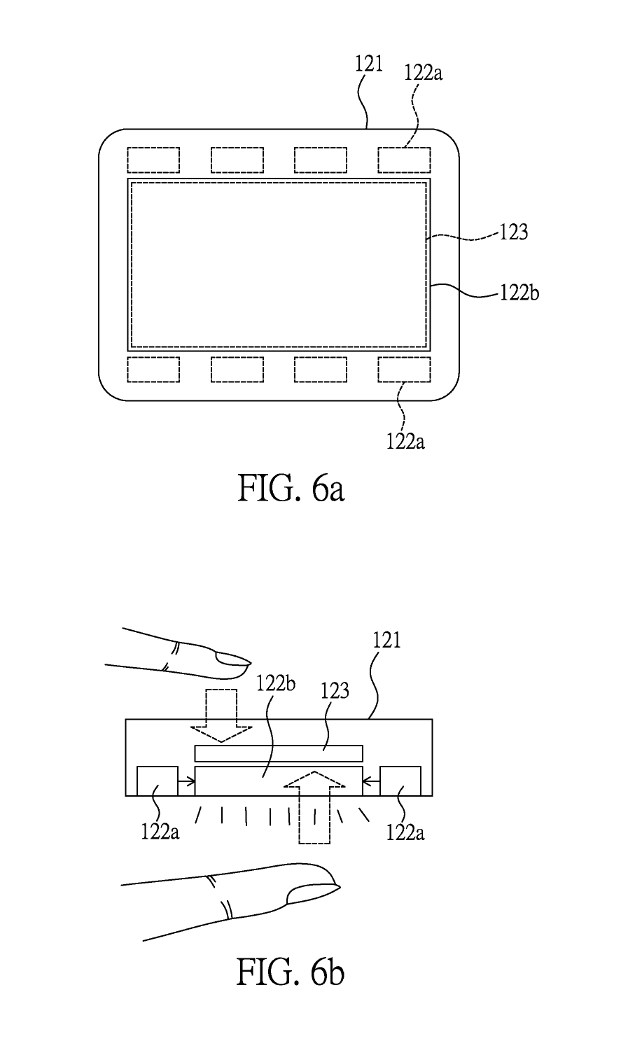

Please refer to FIG. 6a, which illustrates an embodiment of the present invention providing edge-lighting illumination. As illustrated in FIG. 6a, there are from top to bottom a conductive sensor 123 and a light guide plate 122b inside the shell body 121, and there are a plurality of LEDs 122a located at the edges of the light guide plate 122b, wherein the plurality of LEDs 122a have different light colors, and the reflective surface of the conductive sensor 123 is adjacent to or glued to the top surface of the light guide plate 122b. Please refer to FIG. 6b, which illustrates a cross sectional view of the structure of FIG. 6a. As illustrated in FIG. 6b, a user can float a finger above or below the shell body 121 to determine a light emitting status of the LEDs 122a.

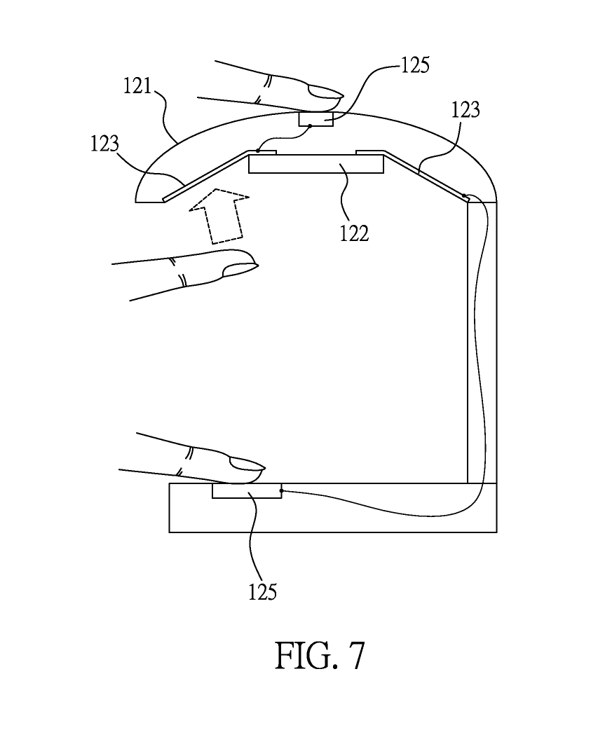

In addition, by installing an extended conductive sensor, which is located inside or outside the shell body 121 and coupled electrically with the conductive sensor 123 via a wire, the present invention can provide a hover operation zone at any location for ease of operation. Please refer to FIG. 7, which illustrates an embodiment of the lighting device of the present invention having at least one extended conductive sensor. As illustrated in FIG. 7, an extended conductive sensor 125 is installed inside the shell body 121, and another extended conductive sensor 125 is installed in the base. The install location of the extended conductive sensor 125 can be determined according to practical requirements. For example, the extended conductive sensor 125 can also be located on the exterior surface of the shell body 121.

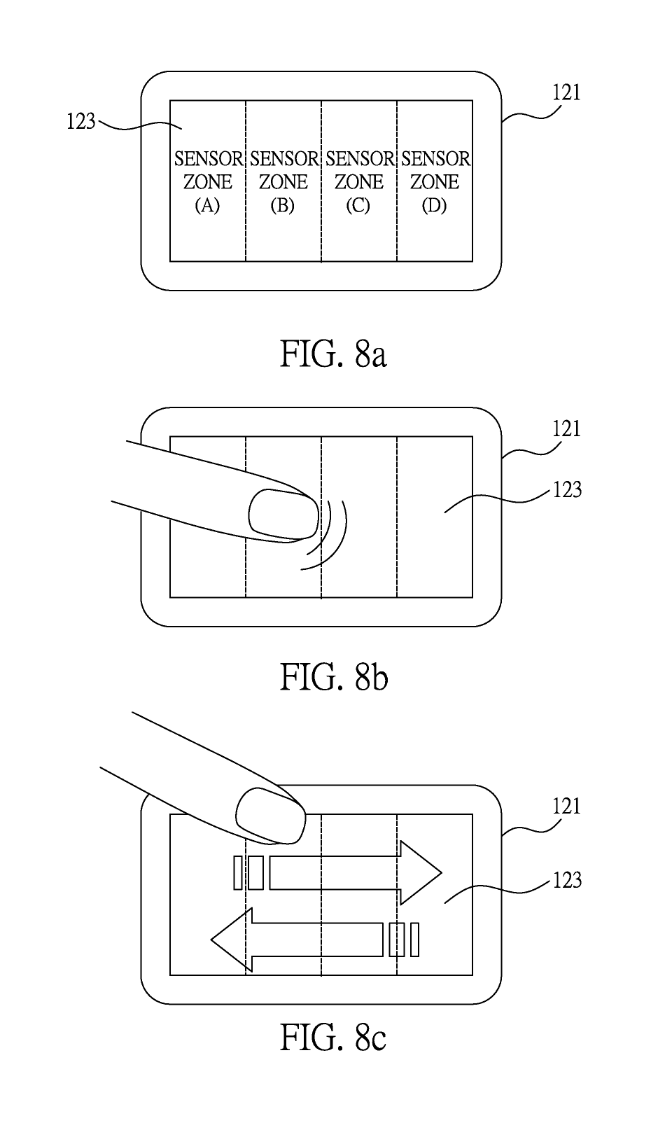

As can be seen from the disclosures above, the lighting device controllable by hover operation of the present invention allows a user to adjust the intensity or color of the light source by a touch operation or a hover gesture operation. For example, when a finger of a user performs a gesture near the shell body 121, the capacitive touch detection circuit 1241 will detect the at least one capacitance change signal T_{P} via the at least one conductive sensor 123 and generate the at least one operation signal accordingly, and the control unit 1243 will control the light source driver circuit 1242 in response to the at least one operation signal to determine a light intensity or a light color of the light source unit 122. Please refer to FIG. 8a, which illustrates an embodiment of the present invention providing conductive sensors 123 in sensor zones A, B, C, and D; FIG. 8b, which illustrates a scenario where a user adjusts the intensity or color of the output light of the light source element 122 by a touching operation; and FIG. 8c, which illustrates a scenario where a user adjusts the intensity or color of the output light of the light source element 122 by a hover gesture operation.

In addition, the present invention can also have a USB (universal serial bus) interface installed on the control unit to transmit data with an information processing device so that the lighting device of the present invention can also be controlled by an external device, and the USB interface can also provide a DC (direct current) power.

Thanks to the novel designs of the present invention, the present invention can provide the advantages as follows:

1. The lighting device controllable by hover operation of the present invention can make use of at least one existing metal part of a general lighting device as at least one sensor electrode to provide a hover function and/or a gesture function.

2. The lighting device controllable by hover operation of the present invention is capable of providing a slim outline.

3. The lighting device controllable by hover operation of the present invention is capable of providing a curved surface for both outputting light and sensing a hover operation.

4. The lighting device controllable by hover operation of the present invention allows a user to adjust the intensity and color of the output light by a hover operation or a gesture operation.

5. The lighting device controllable by hover operation of the present invention is capable of preventing dust and water from entering the device.

6. The lighting device controllable by hover operation of the present invention is capable of prolonging the operation life time of the device.

While the invention has been described by way of example and in terms of preferred embodiments, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

In summation of the above description, the present invention herein enhances the performance over the conventional structure and further complies with the patent application requirements and is submitted to the Patent and Trademark Office for review and granting of the commensurate patent rights.

What is claimed is:

1. A lighting device controllable by hover operation, comprising:
a shell body;
a light source unit located inside said shell body;
at least one conductive sensor located inside said shell body; and
a circuit board including a capacitive touch detection circuit, a light source driver circuit, and a control unit, said capacitive touch detection circuit being coupled electrically with said at least one conductive sensor, said light source driver circuit being coupled electrically with said light source unit, and said control unit being coupled electrically with both said capacitive touch detection circuit and said light source driver circuit;
wherein, when a finger or a palm of an operator approaches at least one active region of said shell body during a control operation, each of said at least one active region being opposing one of said at least one conductive sensor, said capacitive touch detection circuit will detect at least one capacitance change signal via said at least one conductive sensor and generate at least one operation signal accordingly, and said control unit will control said light source driver circuit in response to said at least one operation signal to determine a light emitting status of said light source unit.

2. The lighting device controllable by hover operation as disclosed in claim 1, wherein at least one of said at least one conductive sensor has a light reflective surface.

3. The lighting device controllable by hover operation as disclosed in claim 1, wherein at least one of said at least one conductive sensor is also used as a heat dissipating member.

4. The lighting device controllable by hover operation as disclosed in claim 1, wherein said light source unit includes at least one LED.

5. The lighting device controllable by hover operation as disclosed in claim 2, wherein said light source unit further includes a light guide plate, said at least one LED is located on at least one edge of said light guide plate, and said light reflective surface of one of said at least one conductive sensor is adjacent to a top surface of said light guide plate.

6. The lighting device controllable by hover operation as disclosed in claim 2, wherein said light source unit further includes a light guide plate, said at least one LED is located on at least one edge of said light guide plate, and said light reflective surface of one of said at least one conductive sensor is glued to a top surface of said light guide plate.

7. The lighting device controllable by hover operation as disclosed in claim 1, wherein said light source unit has a plurality of colors of light.

8. The lighting device controllable by hover operation as disclosed in claim 1, wherein said light source unit includes at least one OLED.

9. The lighting device controllable by hover operation as disclosed in claim 1, wherein when said finger or said palm performs a gesture near said shell body, said capacitive touch detection circuit will detect said at least one capacitance change signal via said at least one conductive sensor and generate said at least one operation signal accordingly, and said control unit will control said light source driver circuit in response to said at least one operation signal to determine a light intensity of said light source unit.

10. The lighting device controllable by hover operation as disclosed in claim 1, wherein said light source unit has a plurality of colors of light, and when said finger or said palm performs a gesture near said shell body, said capacitive touch detection circuit will detect said at least one capacitance change signal via said at least one conductive sensor and generate said at least one operation signal accordingly, and said control unit will control said light source driver circuit in response to said at least one operation signal to determine a light color of said light source unit.

11. The lighting device controllable by hover operation as disclosed in claim 1, further including an extended conductive sensor located inside or outside said shell body and coupled electrically with said at least one conductive sensor via a wire.

12. The lighting device controllable by hover operation as disclosed in claim 1, wherein said control unit has a USB interface for transmitting data with an information processing device or for providing a DC power.
